(19) United States
(12) Patent Application Publication
(10) Pub. No.: US 2005/0234583 A1
(43) Pub. Date: Oct. 20, 2005

(54) METHODS AND SYSTEMS FOR ONLINE EMBRIDERY DATA PROCESSING

(76) Inventor: Alexander Kantarovich, Long Grove, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/907,910

(22) Filed: Apr. 20, 2005

Related U.S. Application Data
(60) Provisional application No. 60/521,405, filed on Apr. 20, 2004.

(51) Int. Cl. G06F 19/00

(52) U.S. Cl. 700/138

(57) ABSTRACT

A system and method for creating works using software on a server accessed online is disclosed. The works are then downloadable in electronic format which can be used in conjunction with another machine. In certain embodiments, the software is embroidery design software which enables the user to create embroidery design data files and download them for use on an embroidery machine. In various embodiments, users are enabled to upload existing embroidery design data files and modify them or convert them, or upload non-embroidery design graphics files and convert them into embroidery design data files. Multiple users may be given access to the same file stored on the server. A subscription system can be implemented to charge users for use based on projects, functionality, time, or flat rates.

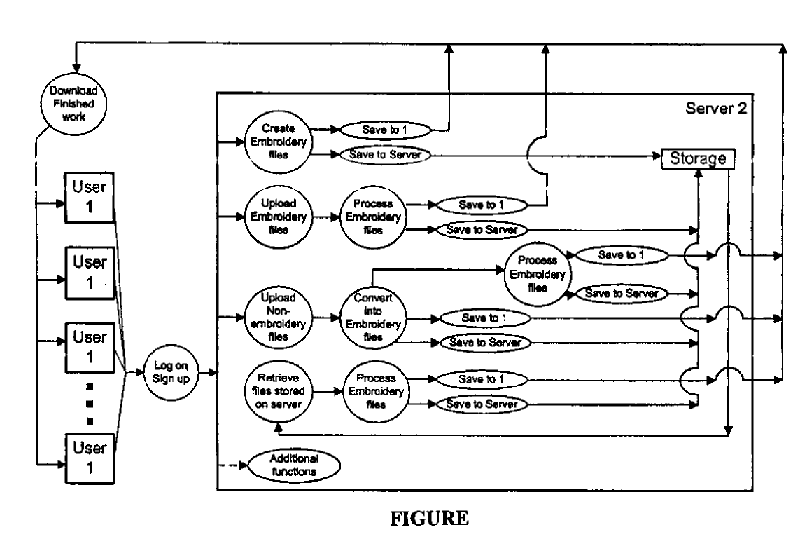

This application claims the benefit of U.S. Provisional Application No. 60/521,405, filed Apr. 20, 2004, which is hereby incorporated by reference herein in its entirety.

### BACKGROUND OF THE INVENTION

1. Field of the Invention

The present invention relates to creating and using embroidery designs via a computer network, and more specifically, to a system and method for providing access to embroidery design software and downloading machine readable files.

2. Description of the Related Art

Embroidery machines which make use of electronic data files to create embroidery designs are known and have been used for a number of years. Such machines require that embroidery design software be utilized in order to create files which can be read by these machines. Embroidery design software can be rather expensive, and for individuals and small businesses, it may be cost prohibitive to own such software.

Various online systems exist in which a user is able to create a work online. However, such works have heretofore been limited to works intended for use on the user's computer, or for use in placing an order to be filled by the owner or affiliated entity of the website.

U.S. Pat. No. 6,216,618, issued to Goldberg et al., discloses an embroidery system using a Windows CE interface. This system enables a user to interface with an embroidery machine, such as over a network, however, it does not allow a user to access design software over the internet, nor download machine readable works for use on a machine.

U.S. Pat. No. 6,196,146, issued to Goldberg et al., discloses a web based system for embroidery design and order. The user is able to customize designs and place orders. However, the user does not actually interface with embroidery software online, and there is no system to enable a user to download a machine readable embroidery design. The system is merely for the purpose of ordering an item having a particular embroidery design, and fulfilling that order on the service side.

U.S. Pat. No. 6,836,695, issued to Goldman, discloses a method of generating an embroidery design from a scanned image. Data from the scanned image is converted into embroidery design data. Again, users are not enabled to use online software to create a work, nor can they download it from such software to use on an embroidery machine.

Thus, nothing in the prior art addresses the need for users to access software online in an economical fashion, and download works which can be used in electronic format on a different machine, such as an embroidery machine.

Therefore, there remains a need for a system and method to enable a user to create a creative work online, download it in electronic format such that it is usable to operate another machine.

### SUMMARY

In view of the deficiencies described above, it is an object of the present invention to provide a system and method of enabling a user to create creative works online and download such works for use on other machines.

The present invention is a system and method of providing access to software online, allowing a user to create a creative work using the software, and allowing the user to download the work in an electronic format which is usable on another machine.

Access to the software may be restricted using a subscription system. In this manner, a user is able to make use of otherwise expensive software in a manner which is more economical according to the user's needs.

In certain embodiments of the present invention, the software is embroidery design software which is located on a server. The user can access the server, such as over the internet, and create an embroidery design which is downloadable in embroidery machine readable format. In various embodiments, the system is enhanced with the capabilities to allow the user to upload embroidery design data files, modify them, convert them to other formats, upload graphics design files and convert them to embroidery design data files, or perform various other functions.

In certain embodiments, multiple users can collaborate efforts such as by having one user save a file on the server, and a subsequent user access the file and further modify it.

Files can be created using previously saved designs, which can then also be modified.

Thus, the system of the present invention enables a user to create works, such as embroidery design data files, and download them to make use of them on another machine such as an embroidery machine, without having to purchase or license the design software directly.

Other features and advantages of the invention will be apparent from the following detailed description taken in conjunction with the following figures, wherein like reference numerals represent like features.

### BRIEF DESCRIPTION OF THE FIGURE

The FIGURE shows a flow chart depicting the system and method of the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

In various embodiments, the present invention is a system for creating and using creative works. It is intended that any work, such as text, programming, pictorial or graphic works, and other works are included within the definition of creative works. The invention includes a software application located on a server accessible to users via a computer network, such as the internet. The software application is usable by such users to create a creative work in that the users are able to access the software, and make use of the software to produce such a work.

Means for such users to access the software via a computer network are provided, such as network access to a server via a website. Optionally, access can be restricted via subscription system. In such a manner, users would be provided with access to the software and would pay, either per project, per time of usage, or on a regular rate such as a flat fee per period of time. In this manner, users might be able to make use of the software in a manner which would be more economical than owning or licensing the software. Such a subscription system can be activated by having the user register on an associated website, create a customer profile, and provide information such as contact information and payment information. Various different payment schemes can be used based on the usage and functionality desired.

Users are enabled to download their creative work in an electronic format. Once downloaded, the file can be used to provide operable instructions to a machine different than a computer from which such users access the software.

In various embodiments of the present invention, a memory component, such as a hard drive on the server, or other memory device, is provided. A subsequent user is able to make use of a file saved on the memory device. The subsequent user can modify the file to create another creative work.

In certain embodiments of the present invention, the software application is an embroidery design software application which allows the user to create an embroidery design data file. The creative work is an embroidery design data file which is readable by an embroidery machine. Such machines can make use of numerous different formats, and any such formats are contemplated within the scope of the present invention. Common formats include PES, HUS, VIP, PCS, ART, and JEF file formats, however, any other suitable format readable by an embroidery machine is contemplated.

In various embodiments embroidery design system of the present invention, various features and functionality are optionally provided. For example, users may be enabled to upload an existing embroidery data file, and edit the existing embroidery data file via the software to create the creative work. Users may be enabled to upload an existing non-embroidery design file such as a graphic file, and convert the design file into an embroidery file. Such files could then be further modified using the embroidery design software. Users may be enabled to upload an existing embroidery data file in a first electronic format and convert the existing embroidery data file into a second electronic format which is the creative work. Furthermore, users may be enabled to upload an existing embroidery data file in a first electronic format and convert the existing embroidery data file into a second electronic format, wherein the file in the second electronic format can be further modified via the software to create the creative work.

The method of the present invention includes the steps of providing the functionality and features discussed above with respect to the system of the present invention.

The FIGURE shows a flow chart illustrating the functionality of various embodiments of the present invention. Users are enabled to log onto the system, create or upload various files, modify them, save them or download them, and make use of the files on another machine. For example, the chart shows that a user can log on, have the option of (1) creating embroidery files, which can be either saved to the server for later use or downloaded to the user's computer, or (2) uploading existing embroidery files, which can be processed or edited, and either saved to the server for later use or downloaded to the user's computer, or (3) uploading non-embroidery files, which can be converted into embroidery files, optionally further processed, and either saved to the server for later use or downloaded to the user's computer, or using other functions. In the event a file is saved on the server, it can later be retrieved and further processed or edited, and then again saved on the server or downloaded.

When making use of the embroidery design software, functionality can include allowing the user to make designs in a free-style manner, or enabling the user to make use of, and modify existing designs, or both. Existing designs can be altered with respect to size, shape, color, text content, or in any other desired manner.

While specific embodiments have been illustrated and described, numerous modifications come to mind without significantly departing from the spirit of the invention and the scope of protection is limited by the scope of the accompanying claims.

1. A system for creating and using creative works comprising:
a software application located on a server accessible to users via a computer network wherein said software application is usable by such users to create a creative work, and
means for such users to access said software via a computer network and use said software to create said creative work,
wherein such users are enabled to download said creative work, and wherein said creative work is downloadable in an electronic format which can be used to provide operable instructions to a machine different than a computer from which such users access said software.

2. The system for creating and using creative works according to claim 1, wherein said means for such users to access said software is provided via a subscription system.

3. The system for creating and using creative works according to claim 1, further comprising a memory component on said server, and wherein a subsequent user can access and modify said creative work created by an initial user and saved on said memory component.

4. The system for creating and using creative works according to claim 1, wherein said software application is an embroidery design software application, said creative work is an embroidery design data file, and said electronic format is a format which is readable by an embroidery machine.

5. The system for creating and using creative works according to claim 4, wherein such users are enabled to upload an existing embroidery data file, and edit said existing embroidery data file via said software to create said creative work.

6. The system for creating and using creative works according to claim 4, wherein such users are enabled to upload an existing non-embroidery design file and convert said design file into an embroidery file, wherein said embroidery file is said creative work.

7. The system for creating and using creative works according to claim 4, wherein such users are enabled to upload an existing non-embroidery design file and convert said design file into an embroidery file, wherein said embroidery file can be further modified via said software to create said creative work.

8. The system for creating and using creative works according to claim 4, wherein such users are enabled to upload an existing embroidery data file in a first electronic format and convert said existing embroidery data file into a second electronic format which is said creative work.

9. The system for creating and using creative works according to claim 4, wherein such users are enabled to upload an existing embroidery data file in a first electronic format and convert said existing embroidery data file into a second electronic format, wherein said file in said second electronic format can be further modified via said software to create said creative work.

10. The system for creating and using creative works according to claim 4, further comprising a memory component on said server, and wherein a subsequent user can access and modify said creative work created by an initial user and saved on said memory component.

11. The system for creating and using creative works according to claim 4, wherein said means for such users to access said software is provided via a subscription system.

12. A method for enabling users to create and use creative works comprising the steps of:
providing access to users to a software application located on a server via a computer network wherein said software application is usable by such users to create a creative work, and
wherein such users are enabled to download said creative work, and wherein said creative work is downloadable in an electronic format which can be used to provide operable instructions to a machine different than a computer from which such users access said software.

13. The method for enabling users to create and use creative works according to claim 12, wherein said software application is an embroidery design software application, said creative work is an embroidery design data file, and said electronic format is a format which is readable by an embroidery machine.

14. The method for enabling users to create and use creative works according to claim 13, further comprising the step of providing a memory component on said server and enabling such users to save said creative work on said memory component, and wherein a subsequent user can access and modify said creative work created by an initial user and saved on said memory component.

15. The method for enabling users to create and use creative works according to claim 13, further comprising the step of enabling such users to upload an existing embroidery data file, and edit said existing embroidery data file via said software to create said creative work.

16. The method for enabling users to create and use creative works according to claim 13, further comprising the step of enabling such users to upload an existing embroidery data file, and edit said existing embroidery data file via said software to create said creative work.

17. The method for enabling users to create and use creative works according to claim 13, further comprising the step of enabling such users to upload an existing non-embroidery design file and convert said design file into an embroidery file, wherein said embroidery file is said creative work.

18. The method for enabling users to create and use creative works according to claim 13, further comprising the step of enabling such users to upload an existing non-embroidery design file and convert said design file into an embroidery file, wherein said embroidery file can be further modified via said software to create said creative work.

19. The method for enabling users to create and use creative works according to claim 13, further comprising the step of enabling such users to upload an existing embroidery data file in a first electronic format and convert said existing embroidery data file into a second electronic format which is said creative work.

20. The method for enabling users to create and use creative works according to claim 13, further comprising the step of enabling such users to upload an existing embroidery data file in a first electronic format and convert said existing embroidery data file into a second electronic format, wherein said file in said second electronic format can be further modified via said software to create said creative work.

21. The method for enabling users to create and use creative works according to claim 13, further comprising the step of enabling such users to access said software via a subscription system.
